(19) United States
(12) Patent Application Publication
(10) Pub. No.: US 2020/0092633 A1
(43) Pub. Date: Mar. 19, 2020

(54) BONE CONDUCTION SPEAKER AND SMART WEARABLE DEVICE AS WELL AS RESONANCE PROCESSING METHOD

(71) Applicant: Musiclens Inc, Sangabriel, CA (US)

(72) Inventors: YANYAN ZHANG, SANGABRIEL, CA (US); JUNYI LIU, SANGABRIEL, CA (US); JUNWEN ZOU, SANGABRIEL, CA (US); ZILONG ZHANG, SANGABRIEL, CA (US); FENG LI, SANGABRIEL, CA (US)

(73) Assignee: Musiclens Inc

(21) Appl. No.: 16/178,561

(22) Filed: Nov. 1, 2018

(30) Foreign Application Priority Data
Sep. 18, 2018 (CN) 201811088076.9

(51) Int. Cl. H04R 1/10; G02B 27/01; H04R 5/033; H04R 3/00; H04R 9/02

(52) U.S. Cl. CPC H04R 1/1075; H04R 1/1066; G02B 27/0176; H04R 2460/13; H04R 3/002; H04R 9/025; G02B 2027/0178; H04R 5/0335

(57) ABSTRACT

The present application relates to a bone conduction speaker and a smart wearable device as well as resonance processing method. The bone conduction speaker comprises a speaker body for generating vibration, a vibration sound transmitting layer in contact with a port of the speaker body for propagating vibration generated by the speaker body, and a vibration damping layer that wraps a region other than a portion of the speaker body that is in contact with the vibration sound transmitting layer. The smart wearable device is provided with the bone conduction speaker and is in direct contact with the user's body; the resonance processing method comprises filtering an audio signal within the preset frequency range or adjusting a gain of an audio signal within the preset frequency range.

### CROSS-REFERENCE TO RELATED APPLICATIONS

This application claims priority to Chinese Patent Application No. 201811088076.9 with a filing date of Sep. 18, 2018. The content of the aforementioned applications, including any intervening amendments thereto, are incorporated herein by reference.

### TECHNICAL FIELD

The invention relates to the field of terminal technology, in particular, to a bone conduction speaker, a smart wearable device using the bone conduction speaker, and a processing method for the resonance generated by the bone conduction speaker in this device.

### BACKGROUND TECHNOLOGY

There are two ways to propagate sound: one is through air vibration; the other is through direct vibration. Bone conduction speaker transmits sound by directly vibrating human bones or skin tissue. The principle of operation is to convert electrical signals into mechanical vibration signals for mechanically vibrating the sound that travels through human bones or skin tissue. In the related art, the vibration generated by the bone conduction speaker transmits sound by vibration from each direction, resulting in a lack of concentration of the sound, causing a sound leakage, and easily leaking user privacy.

### SUMMARY OF THE INVENTION

The present application provides a bone conduction speaker and a smart wearable device as well as resonance processing method so as to solve the deficiencies in the related art.

The present invention has been achieved in accordance with the following technical solutions.

According to the first aspect of the embodiment of the present application, a bone conduction speaker is provided comprising a speaker body for generating vibration, a vibration sound transmitting layer in contact with a port of the speaker body for propagating vibration generated by the speaker body, and a vibration damping layer that wraps a region other than a portion of the speaker body that is in contact with the vibration sound transmitting layer.

Optionally, the vibration damping layer includes a first vibration damping layer circumferentially surrounding the speaker body, and a second vibration damping layer in contact with a bottom of the speaker body, the first vibration damping layer and the second vibration damping layer being used to isolate a portion of the vibration generated by the speaker body.

Optionally, the first vibration damping layer includes a recess formed to be recessed inward from a surface of the first vibration damping layer.

Optionally, the first vibration damping layer includes an elastic column located on a surface of the first vibration damping layer facing the second vibration damping layer and in contact with the second vibration damping layer.

Optionally, the first vibration damping layer is in an interference fit with the speaker body.

Optionally, the speaker body includes a housing including a receiving cavity in communication with the exterior, a circuit board fitted to the housing to close the receiving cavity, and a vibrating piece located in the receiving cavity and connected to an inner wall of the housing to allow the housing to generate vibration; wherein the housing is in contact with the vibration sound transmitting layer and the vibration damping layer.

Optionally, the speaker body further includes a first gasket between the vibrating piece and the circuit board, and the housing includes an abutting portion formed by bending inwardly, the abutting portion being in contact with one side of the circuit board and the first gasket being in contact with the opposite side of the circuit board to limit the circuit board.

Optionally, the speaker body further includes a coil electrically connected to the circuit board, a bracket connected to the vibrating piece and including a groove facing the coil, and a magnet located in the groove; wherein there is a gap between the coil and an inner wall of the groove.

Optionally, the speaker body further includes a tuning cotton connected to a surface of the vibrating piece facing the bottom of the receiving cavity and/or a surface of the circuit board facing the bottom of the receiving cavity.

According to the second aspect of the embodiment of the present application, a smart wearable device is provided comprising the bone conduction speaker according to any one of the above embodiments;

wherein the vibrating sound transmitting layer is in contact with the user when the wearable device is in the worn state.

According to the third aspect of the embodiment of the present application, a resonance processing method is provided to be applied to a smart wearable device including the bone conduction speaker, the method comprising:

acquiring an audio signal;

determining whether the frequency of the audio signal is within a preset frequency range, the preset frequency range including a natural frequency of the bone conduction speaker;

processing the audio signal when the frequency of the audio signal is within the preset frequency range to prevent resonance.

Optionally, processing the audio signal includes:

filtering the audio signal within the preset frequency range;

or adjusting the gain of the audio signal within the preset frequency range.

The technical solutions provided by the embodiments of the present application may include the following beneficial effects:

As can be seen from the above embodiments, in the present application, the vibration damping layer and the vibration sound transmitting layer jointly wrap the speaker body, so that the vibration generated on the speaker body is transmitted through the vibration sound transmitting layer. The vibration damping layer may prevent the vibration generated on the speaker body from propagating from all directions, prevent the bone conduction speaker from generating sound leakage, improve the sound leakage problem of the bone conduction speaker in the related art, protect the user privacy, and enhance the user experience.

### BRIEF DESCRIPTION OF THE DRAWINGS

FIG. 1 is an exploded view of the bone conduction speaker of the present invention;

FIG. 2 is a first application scenario view of the bone conduction speaker of the present invention;

FIG. 3a is a structural view of the first vibration damping layer in the present invention;

FIG. 3b is a cross-sectional view of the first vibration damping layer in the present invention;

FIG. 4 is a cross-sectional view of a speaker body in the present invention;

FIG. 5 is a second application scenario view of the bone conduction speaker of the present invention;

FIG. 6 is a partial enlarged view of FIG. 5;

FIG. 7 is a flow chart of the resonance processing method in the present invention;

FIG. 8 is a graph showing the relationship between the vibration intensity and the frequency of the bone conduction speaker of the present invention.

Among them, 100. bone conduction speaker; 200. smart wearable glass; 1. speaker body; 2. vibration sound transmitting layer; 3. vibration damping layer; 31. first vibration damping layer; 32. second vibration damping layer; 311. recess; 11. housing; 12. circuit board; 13. vibrating piece; 111. receiving cavity; 14. first gasket; 15. second gasket; 16. coil; 17. bracket; 171. groove; 18. magnet; 19. tuning cotton.

### EMBODIMENTS OF THE INVENTION

The present invention will be further described below in combination with reference to drawings and embodiments.

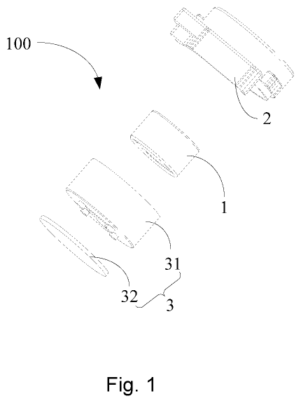

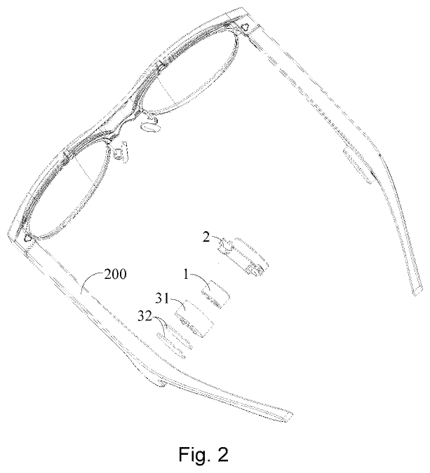

As shown in FIGS. 1 to 8, FIG. 1 is an exploded view of a bone conduction speaker 100, according to an exemplary embodiment. As shown in FIG. 1, the bone conduction speaker 100 comprises a speaker body 1, a vibration sound transmitting layer 2 and a vibration damping layer 3. Among them, the speaker body 1 may generate vibration based on a change in a magnetic field in the speaker body 1, and the vibration sound transmitting layer 2 is in contact with a part of the speaker body 1, so that the vibration generated on the speaker body 1 may be transmitted through the vibration sound transmitting layer 2. And, as shown in FIG. 2, when the bone conduction speaker 100 is assembled with a pair of smart wearable glasses 200, the vibration sound transmitting layer 2 is in contact with the user, thereby transmitting the vibration generated by the speaker body 1 to the user's bone to cause vibration so that the user may hear the sound. For example, music, video sounds, recordings, etc.

The vibration damping layer 3 wraps a region other than a portion of the speaker body 1 that is in contact with the vibration sound transmitting layer 2, thereby preventing the vibration generated on the speaker body 1 from propagating from various directions, preventing the bone conduction speaker 100 from generating a sound leakage, so that the serious problem of sound leakage of bone conduction speaker in related art is improved.

Among them, it should be noted that the vibration damping layer 3 wraps the other areas of the speaker body 1 other than a part of the area in contact with the vibration sound transmitting layer 2, which may be understood as: the sum of the other areas and the area of the speaker body 1 that is in contact with the vibration sound transmitting layer 2 may be exactly equal to the entire surface area of the speaker body 1; or it is also possible that the sum of the other areas and the area of the speaker body 1 that is in contact with the vibration sound transmitting layer 2 is slightly smaller than the entire surface area of the speaker body 1, and may be, for example, more than 80% of the surface area of the speaker body 1.

In an embodiment, the sound damping layer 3 may be a unitary structure including a groove for assembling the speaker body 1, at this time, an interference fit between the vibration damping layer 3 and the speaker body 1 prevents the speaker body 1 from vibrating in the vibration damping layer 3. Or in another embodiment, the sound damping layer 3 may also adopt a split structure, and still referring to FIGS. 1 and 2, the vibration damping layer 3 includes a first vibration damping layer 31 circumferentially surrounding the speaker body 1, and a second vibration damping layer 32 in contact with a bottom of the speaker body 1, the first vibration damping layer 31 and the second vibration damping layer 32 being used to isolate a portion of the vibration generated by the speaker body 1. Since the sound damping layer 3 adopts a split structure, it is convenient to process the appearance structure of the speaker body 1 so as to be matched with the speaker body 1 to avoid sound leakage.

Among them, the first vibration damping layer 31 may be in an interference fit with the speaker body 1 to avoid the speaker body 1 from shaking in the first vibration damping layer 31. For example, there may be an interference rate of 0.1 mm between the first vibration damping layer 31 and the speaker body 1 to stabilize the speaker body 1 while ensuring that the speaker body 1 may be assembled into the first vibration damping layer 31.

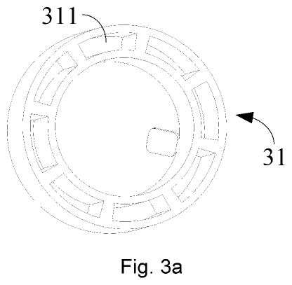

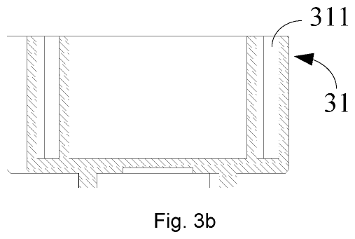

Based on the embodiments shown in FIGS. 1 and 2, as shown in FIGS. 3a and 3b, the first vibration damping layer 31 may include a recess 311, and the recess 311 is formed to be recessed inward from the surface of the first vibration damping layer 31 to enhance buffering effect of the first vibration damping layer 31 on the vibration, reduce the amount of vibration transmitted to the second vibration damping layer 32 via the first vibration damping layer 31.

Still as shown in FIG. 3, the first vibration damping layer 31 may include an elastic column 312, and the elastic column 312 may be located on a surface of the first vibration damping layer 31 facing the second vibration damping layer 32 and in contact with the second vibration damping layer 32 to enhance the buffering effect between the first vibration damping layer 31 and the second vibration damping layer 32.

In each of the above embodiments, the first vibration damping layer 31 may be made of a material that is elastic and has a small hardness, for example, one or more of a silicone rubber, a rubber or a TPU (Thermoplastic polyurethanes) material may be used, which is not limited in the present application. The second vibration damping layer 32 may be made of a material having a large material density, a large elasticity, and a compressibility, and the size of the second vibration damping layer 32 may be designed according to the compression ratio of the material.

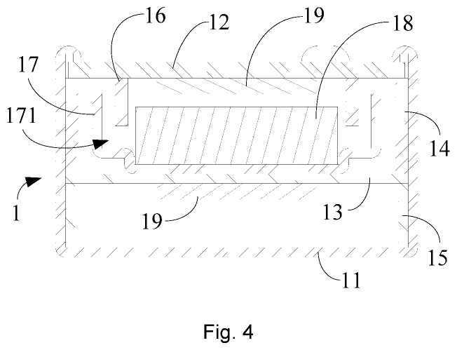

Based on the embodiment of the present disclosure, as shown in FIG. 4, the speaker body 1 may include a housing 11, a circuit board 12, and a vibrating piece 13. Among them, the housing 11 may include a receiving cavity 111 in communication with the exterior, a circuit board 12 fitted to the housing 11, and a vibrating piece 13 located in the receiving cavity 111 and connected to an inner wall of the housing 11. Thereby, since the circuit board 12 is fitted to the housing 111, the receiving cavity 111 may be closed, so that vibration generated by the vibrating piece 13 may be transmitted to the housing 11, causing vibration generated by the housing 11.

The housing 11 may be further in contact with the vibration damping layer 3 and the vibration sound transmitting layer 2 to transmit sound through the vibration sound transmitting layer 2 and to prevent sound leakage through the vibration damping layer 3. Further, due to the sealing action of the circuit board 12, the vibration generated by the vibrating piece 13 does not transmit to outside through the opening of the housing 11, so that the external air vibration is prevented from being caused by the vibration of the vibrating piece 13, the sound leakage is improved, the sound transmitting effect of the bone conduction speaker 100 is improved, and the privacy of the user is protected.

In the present embodiment, the speaker body 1 further includes a first gasket 14 between the vibrating piece 13 and the circuit board 12, and the housing 11 may include an abutting portion 112 formed by bending inwardly, the abutting portion 112 being in contact with one side of the circuit board 12 and the first gasket 14 being in contact with the opposite side of the circuit board 12 so as to limit the circuit board 12 in the opposite two directions by the first gasket 14 and the abutting portion 112, thereby avoiding the shaking of the circuit board 12.

Further, the speaker body 1 may further include a second gasket 15, and the second gasket 15 is located between the vibrating piece 13 and the bottom of the housing 11 to support the vibrating piece 13 through the second gasket 15, improve the strength of the vibrating piece 13, avoid deformation, and ensure the sound effect of the bone conduction speaker 100.

Among them, the first gasket 14 and the second gasket 15 may be made of a non-metallic material having a small density to reduce the weight of the first gasket 14 and the second gasket 15, reduce the weight of the bone conduction speaker 100, and enhance the user experience.

Still as shown in FIG. 4, the speaker body 1 may further include a coil 16, a bracket 17, and a magnet 18. Among them, the coil 16 is connected to the circuit board 12 such that a magnetic field is generated when a current is applied to the coil 16; the bracket 17 is connected to the vibrating piece 13 and includes a recess 171 arranged toward the coil 16, and the magnet 18 is placed in the recess 171, so that a magnetic field generated by the magnet 18 interacts with a magnetic field generated by the coil 16 to cause the vibrating piece 13 to vibrate. Among them, there is a gap between the coil 16 and an inner wall of the groove 171. Based on the gap, the bandwidth of the bone conduction speaker 100 may be increased to enhance the bass effect of the bone conduction speaker 100. For example, the inner wall of the groove 171 may be understood as the vertical wall of the groove 171. The gap between the vertical wall and the coil 16 is between 1 and 1.5 mm, for example, 1.2 mm, 1.3 mm, 1.4 mm, etc., which is not limited in the present application.

In each of the above embodiments, the speaker body 1 may further include a tuning cotton 19, and in an embodiment, the tuning cotton 19 may be connected to the surface of the vibrating piece 13 facing the bottom of the receiving cavity 111; or in another embodiment, the tuning cotton 19 may be connected to the surface of the circuit board 12 facing the bottom of the receiving cavity 111; or in another embodiment, as shown in FIG. 4, the tuning cotton 19 may be arranged on both surfaces of the circuit board 12 and the vibrating piece 13 facing the bottom of the receiving cavity 111 to improve the sounding effect of the bone conduction speaker 100.

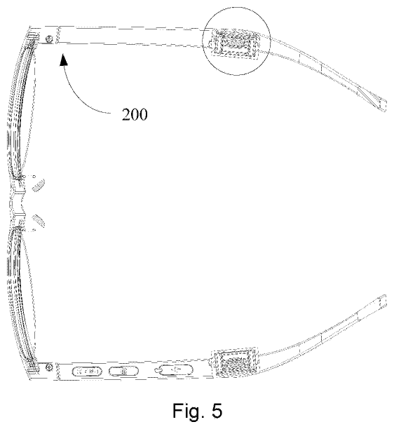

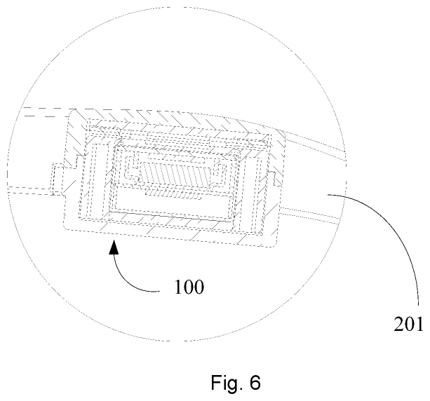

Based on the bone conduction speaker 100 provided in the present application, as shown in FIGS. 5 and 6, here, the bone conduction speaker 100 is assembled to the smart glasses 200 as an example to describe the sound transmission process of the bone conduction speaker 100. Specifically, the bone conduction speaker 100 may be assembled on an arm 201 of the smart glasses 200, and for the stereo effect, the bone conduction speaker 100 provided in the present application may be arranged on both of the arms 201 of the smart glasses 200.

When the smart glasses 200 is connected to an external audio device, for example, by a wireless connection or a Bluetooth connection, the glasses body 200 generates a current according to an audio signal generated by the received external audio device, the current is passed through the coil 16 to generate a magnetic field, and the magnetic field generated by the coil 16 interacts with the magnetic field generated by the magnet 18, so that the vibrating piece 13 is caused to vibrate, and the vibration generated by the vibrating piece 13 is transmitted to the housing 11, thereby, the housing 11 vibrates, and further the vibration may be transmitted to the vibration sound transmitting layer 2 which is in contact with the housing 11, and the vibration sound transmitting layer 2 comes into contact with the user, finally, the bone in the user body vibrates to realize sound propagation.

Among them, the vibration sound transmitting layer 2 may be made of anti-allergic material to above allergies because the vibration sound transmitting layer 2 needs to be in contact with the user to realize vibration transmission, and the vibration sound transmitting layer 2 may be made of a soft material to achieve a better anti-sound-leakage effect. For example, the vibration sound transmitting layer 2 may be made of one or more materials of silicone, latex, and plastic.

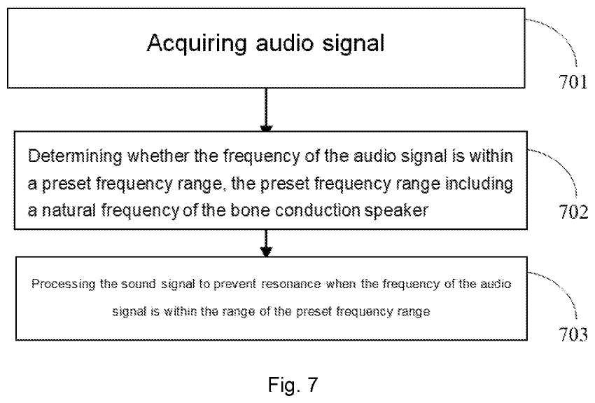

Based on the bone conduction speaker 100 provided by the present application, there is a natural frequency that is related to the inherent characteristics of the bone conduction speaker 100, such as mass, shape, and material. When a signal corresponding to the natural frequency of the bone conduction speaker 100 exists in the external audio signal, resonance may occur. Therefore, the present application further provides a resonance processing method that may be applied to the smart wearable device. The smart wearable device may comprise a bone conduction speaker. The bone conduction speaker may include the bone conduction speaker 100 as described in any one of the above embodiments. Or, it is also possible to use a bone conduction speaker of other structure, which is not limited in the present application. As shown in FIG. 7, the method may comprise the following steps:

Step 701, acquiring an audio signal.

In the present embodiment, taking the smart wearable device being the smart glasses 200 as an example, the smart glasses 200 may be connected to an external audio player to acquire an audio signal. For example, the smart glasses 200 may be connected to an external audio player via Bluetooth, or wirelessly connected to an external audio player, which may include a speaker, a mobile terminal. Or, the smart glasses 200 may also receive radio signals by electromagnetic waves so as to acquire audio signals.

In Step 702, the method comprises determining whether the frequency of the audio signal is within a preset frequency range, the preset frequency range including a natural frequency of the bone conduction speaker.

In the present embodiment, the preset frequency range may be a range that floats up and down based on the natural frequency. For example, it may be a natural frequency of ±10 hz, or a natural frequency of ±5 hz, a natural frequency of ±15 hz, etc., which is not limited in the present application. It should be noted that the smart glasses 200 receive audio signals in the form of a single data packet from an external audio player, therefore, in the present application, the frequency of the audio signal in a single data packet is matched with the preset frequency range to determine whether the audio signal corresponding to the single data packet needs to be processed.

Taking the bone conduction speaker 100 provided in the embodiment of the present application as an example, the natural frequency of the bone conduction speaker 100 may be calculated by a signal transmission function and a frequency response curve. Specifically, the digital signal transmission function is:

H(e^{jw})=|H(e^{jw})|e^{JQ(w)};

wherein |H (e^{jw})| the amplitude-frequency characteristic indicates the attenuation of each frequency after the signal passes through the filter; Q(w) the phase-frequency characteristic indicates the time delay of each frequency component after it passes through the filter.

Related formula for digital signal frequency response curve is:

$$H ( z ) = Y ( z ) \text{/} X ( z ) = {\sum }_{k = 0}^{m} {b}_{k} {z}^{- k} \text{/} ( 1 - {\sum }_{k = 1}^{n} {a}_{k} {z}^{- k} ) ;$$

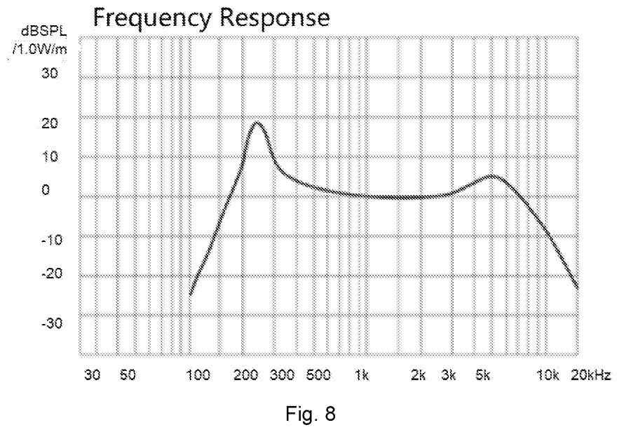

Based on the above manner, as shown in FIG. 8, it may be determined that the natural frequency of the bone conduction speaker 100 provided by the present application is about 240 hz.

Based on this, the preset frequency range may be (230 hz, 250 hz) or (220 hz, 260 hz) or (225 hz, 255 hz), of course, it may be other forms, and will not be described here.

In Step 703, the method comprises processing the audio signal when the frequency of the audio signal is within the preset frequency range to prevent resonance.

In the present embodiment, when the frequency of the audio signal is within a preset frequency range, the audio signal may be processed. Specifically, the audio signal within the preset frequency range may be filtered, or the gain of the audio signal may be adjusted, so that the intensity of the audio signal is attenuated to less than the intensity required to cause resonance of the bone conduction speaker, thereby avoiding causing resonance, preventing the smart glasses from vibrating too much, and preventing a poor user experience.

We claim:

1. A bone conduction speaker, characterized by comprising:
a speaker body for generating vibration;
a vibration sound transmitting layer in contact with a port of the speaker body for propagating vibration generated by the speaker body;
a vibration damping layer that wraps a region other than a portion of the speaker body that is in contact with the vibration sound transmitting layer.

2. The bone conduction speaker according to claim 1, characterized in that the vibration damping layer includes a first vibration damping layer circumferentially surrounding the speaker body, and a second vibration damping layer in contact with a bottom of the speaker body, the first vibration damping layer and the second vibration damping layer being used to isolate a portion of the vibration generated by the speaker body.

3. The bone conduction speaker according to claim 2, characterized in that the first vibration damping layer includes a recess formed to be recessed inward from a surface of the first vibration damping layer.

4. The bone conduction speaker according to claim 2, characterized in that the first vibration damping layer includes an elastic column located on a surface of the first vibration damping layer facing the second vibration damping layer and in contact with the second vibration damping layer.

5. The bone conduction speaker according to claim 3, characterized in that the first vibration damping layer is in an interference fit with the speaker body.

6. The bone conduction speaker according to claim 1, characterized in that the speaker body includes:
a housing including a receiving cavity in communication with the exterior;
a circuit board fitted to the housing to close the receiving cavity;
a vibrating piece located in the receiving cavity and connected to an inner wall of the housing to allow the housing to generate vibration;
wherein the housing is in contact with the vibration sound transmitting layer and the vibration damping layer.

7. The bone conduction speaker according to claim 6, characterized in that the speaker body further includes a first gasket between the vibrating piece and the circuit board, and the housing includes an abutting portion formed by bending inwardly, the abutting portion being in contact with one side of the circuit board and the first gasket being in contact with the opposite side of the circuit board to limit the circuit board.

8. The bone conduction speaker according to claim 6, characterized in that the speaker body further includes:
a coil electrically connected to the circuit board;
a bracket connected to the vibrating piece and including a groove facing the coil;
a magnet located in the groove;
wherein there is a gap between the coil and an inner wall of the groove.

9. The bone conduction speaker according to claim 6, characterized in that the speaker body further includes a tuning cotton connected to a surface of the vibrating piece facing the bottom of the receiving cavity and/or a surface of the circuit board facing the bottom of the receiving cavity.

10. A smart wearable device incorporating the bone conduction speaker according to claim 1, characterized in that the smart wearable device is provided with the bone conduction speaker, and the vibrating sound transmitting layer is in contact with the user's body when the wearable device is in the worn state.

11. A resonance processing method, characterized in that it is applied to a smart wearable device including the bone conduction speaker, the method comprising:
acquiring an audio signal;
determining whether the frequency of the audio signal is within a preset frequency range, the preset frequency range including a natural frequency of the bone conduction speaker;
processing the audio signal when the frequency of the audio signal is within the preset frequency range to prevent resonance.

12. The resonance processing method according to claim 11, characterized in that processing the audio signal includes:
filtering the audio signal within the preset frequency range;
or adjusting the gain of the audio signal within the preset frequency range.
